(19) United States
(12) Patent Application Publication
(10) Pub. No.: US 2023/0259725 A1
(43) Pub. Date: Aug. 17, 2023

(54) DEVICE FOR REUNITED LOST ANIMALS WITH THEIR OWNERS

(71) Applicant: Piper Becker, Austin, TX (US)

(72) Inventor: Piper Becker, Austin, TX (US)

(73) Assignee: Pi Tech Development LLC

(21) Appl. No.: 18/110,309

(22) Filed: Feb. 15, 2023

Related U.S. Application Data
(60) Provisional application No. 63/310,560, filed on Feb. 15, 2022.

(51) Int. Cl. G06K 7/10

(52) U.S. Cl. CPC G06K 7/10366

(57) ABSTRACT

A system is provided for reuniting a lost animal with its owner. The system includes a plurality of implantable tags, and a browser-accessible website which registers users and associates each registered user with at least one of the plurality of implantable tags. The system further includes a software application, and a plurality of mobile devices, wherein each of the plurality of mobile devices is equipped with an operating system, a tangible memory with an instance of the software application installed therein, and a scanning device which is adapted to scan one of the plurality of implantable tags and retrieve identification information therefrom. The system also includes a cloud-based platform which accepts queries from instances of the software application installed on the plurality of mobile devices and returns responses thereto, wherein each of the queries contains identification information retrieved from one of the plurality of implantable tags, and wherein each of the responses contains contact information for a registered user associated with the implantable tag.

### CROSS-REFERENCE TO RELATED APPLICATIONS

This application claims the benefit of priority from U.S. Provisional Application No. 63/310,560, filed Feb. 15, 2022, having the same inventor and the same title, and which is incorporated herein by reference in its entirety.

### FIELD OF THE DISCLOSURE

The present application relates generally to implantable devices, and more specifically to systems and methodologies which leverage implantable devices for the purpose of identifying lost animals and reunited them with their owners.

### BACKGROUND OF THE DISCLOSURE

Various systems and methodologies exist in the art for identifying lost animals and reuniting them with their owners. For example, it is common to equip dogs with collars having identification tags thereon. These tags may identify to owner of the animal and may provide contact information to allow the animal to be reunited with its owner in the event that the animal is lost. However, this approach is subject to failure if the collar is separated from the animal, or if the animal is not wearing the collar at the time the animal is lost. This approach is also ineffective in preventing theft of the animal, since collars are easily removed and discarded.

In light of these shortcomings, implantable microchips have been developed which may be embedded in an animal. These chips typically operate at frequencies of 125 kHz, 128kHz, or 134.2 kHz, with 134.2 kHz being the current ISO standard. Implantable microchips of this type are passive devices which are “excited” and read by an appropriate scanner. Successful reading of the implanted chip yields a serial number which uniquely identifies the manufacturer of the microchip. This serial number can be used in conjunction with a pet registry or a pet microchip lookup site (such as, for example, www.petmicrochiplookup.org) to retrieve the name of the chip manufacturer. The manufacturer is then contacted and given the serial number and location of the animal. The manufacturer then contacts the owner of the animal and provides them with the location at which the animal was found and contact information for the party holding the animal, which will typically be the party that contacted the manufacturer. If all goes well, the lost animal may then be reunited with its owner.

The foregoing process has several shortcomings. First of all, the process of reuniting a lost animal with its owner involves many steps, each of which represents a potential point of failure. Secondly, this process relies heavily on the goodwill of the party that finds the animal. Thirdly, it is typically necessary for the lost animal to be brought to a facility with specialized equipment so that the embedded chip can be scanned. Aside from the inconvenience and logistics involved, this step is prone to error because the location and orientation of implanted chips may vary and can shift over time. Moreover, current chips must frequently be read from a very short distance. Hence, correctly reading an embedded chip with a reader can require some knowledge and experience.

### BRIEF DESCRIPTION OF THE DRAWINGS

FIG. 1 is an illustration of a system in accordance with the teachings herein for reuniting a lost animal with its owner.

FIG. 2 is an illustration of four different types of RFID technology currently available which are defined by different standards and offer varying read ranges (see “Navigating Your Way Through the RFID Jungle”, Texas Instruments, Klemens Sattlegger and Uli Denk, Product Managers, Security and Communication, March 2014).

### SUMMARY OF THE DISCLOSURE

In one aspect, a system is provided for reuniting a lost animal with its owner. The system comprises a plurality of implantable tags; a browser-accessible website which registers users and associates each registered user with at least one of said plurality of implantable tags; a software application; a plurality of mobile devices, wherein each of said plurality of mobile devices is equipped with an operating system, a tangible memory with an instance of the software application installed therein, and a scanning device which is adapted to scan one of the plurality of implantable tags and retrieve identification information therefrom; and a cloud-based platform which accepts queries from instances of the software application installed on the plurality of mobile devices and returns responses thereto, wherein each of the queries contains identification information retrieved from one of the plurality of implantable tags, and wherein each of the responses contains contact information for a registered user associated with the implantable tag.

In another aspect, a method is provided for reuniting a lost animal with its owner. The method comprises providing a software application; providing at least one implantable tag to each of a plurality of users, wherein each of said plurality of users is associated with a mobile device equipped with an operating system, a tangible memory with an instance of the software application installed therein, and a scanning device which is adapted to scan one of the plurality of implantable tags and retrieve identification information therefrom; using a browser-accessible website to register each of the plurality of users and to associate each registered user with at least one of said plurality of implantable tags; and using a cloud-based platform to accept queries from instances of the software application installed on the plurality of mobile devices and to return responses thereto, wherein each of the queries contains identification information retrieved from one of the plurality of implantable tags, and wherein each of the responses contains contact information for a registered user associated with the implantable tag.

### DETAILED DESCRIPTION

There is a need in the art for systems and methods for reuniting lost animals with their owners. In particular, there is a need for such systems and methods that have fewer points of failures than existing systems and methods, and that does not require the use of specialized equipment in order for good Samaritans to contact the owner of a lost animal and provide information sufficient to allow the lost animal to be reunited with its owners. These and other needs may be met by the systems and methodologies disclosed herein.

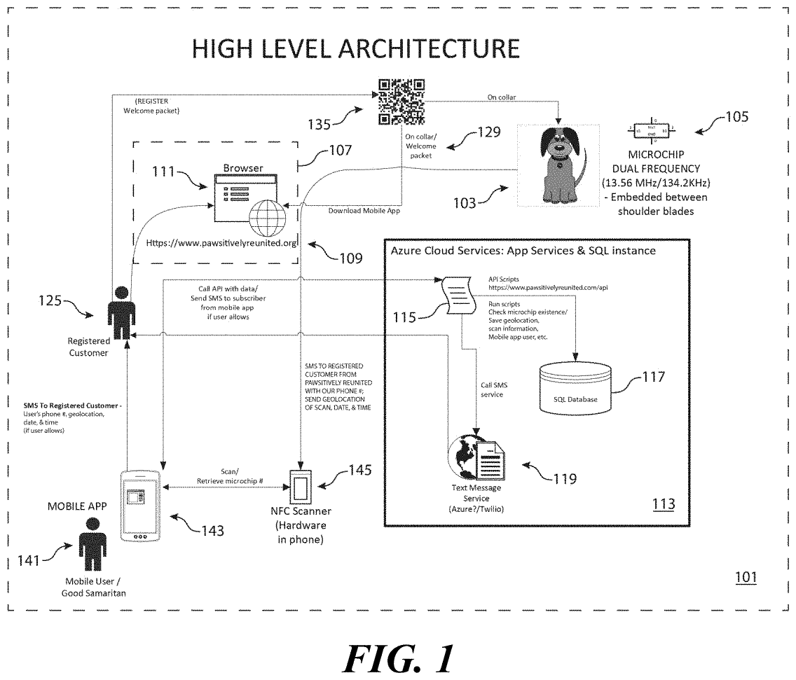

Referring to FIG. 1, a first particular, nonlimiting embodiment of a system in accordance with the teachings herein for reuniting a lost animal with its owner is depicted. The system 101 comprises an animal 103 (here, a dog) with an embedded microchip 105. In this particular embodiment, the microchip 105 is a dual frequency (13.56 MHz/134.2 kHz) microchip that has been embedded between the shoulder blades of the animal 103.

An organization 107 exists which is in the business of reuniting lost animals with their owners. The organization has associated with it a browser-accessible website 109 and a mobile application 111. The mobile application 111 is downloadable from the website 109 or from a third-party service such as, for example, the Apple® app store or Google Play® app store. The organization 107 further has associated with it a server backend 113 which runs application programming interface (API) scripts 115 that serve as an interface between the mobile application 111 and a suitable scripting language. Suitable scripting languages used for this purpose may include, for example, Bash, PowerShell, sed, AWK, Perl, Python, Tcl, JavaScript (or its successor ECMAScript), Kotlin, Visual Basic for Applications, Lua, or Lisp.

The server backend 113 further maintains one or more databases 117 (which are preferably SQL databases), and a text message service 119. The text message service 119 is preferably a short message service (SMS) and may, for example, utilize Twilio bindings in Azure functions, the later of which may be created, for example, using a suitable programming language such as C #, F #, JavaScript, Java, or Python.

In use, an individual 125 associated with an animal 103, and further associated with a mobile device that has a browser installed thereon, receives a welcome packet 129 as part of a registration process by which the individual becomes a registered customer. The welcome packet 129 includes a collar and a microchip 105, which the individual has embedded into their associated animal by, for example, a veterinarian or other suitable party.

The collar is equipped with a QR code 135. The individual scans the QR code 135 with their associated mobile device, which takes the browser to a website from which the mobile application 111 can be downloaded. The individual uses this application to complete registration of their associated animal 103 with the organization 107 and the services provided by the organization 107. The registration process may involve, for example, obtaining contact information from the individual. This contact information may include the identity, addresses, and phone numbers associated with a party who should be contacted in the event that the animal is lost or stolen and subsequently recovered by a third party. The registration process may further involve obtaining information about the animal such as, for example, it's breed, species, color, weight, disposition, shots (for example, rabies vaccinations) and the like.

After the foregoing registration process by which the animal 103 is registered with the organization 107 and/or the services provided by the organization 107, the forgoing contact information and animal information are entered into the one or more databases 117. If the animal 103 is lost or stolen and is subsequently recovered by a third party 141 (such as, for example, a good Samaritan, an animal rescue group, a dog pound, or the like), the third party 141 may use an instance of the mobile application installed on a mobile device 143 to scan the microchip 105 using NFC scanner hardware 145 native to their mobile device 143. Doing so will provide the third party 141 with access to functionality in the mobile application 111 by which the third party 141 may contact the registered customer 131 and provide information (such as, for example, the current location of the animal 103 or contact information for a person or entity having custody of it) suitable to allow the registered customer 131 to be reunited with their associated animal 103. The foregoing information may be exchanged, for example, via the text messaging service 119.

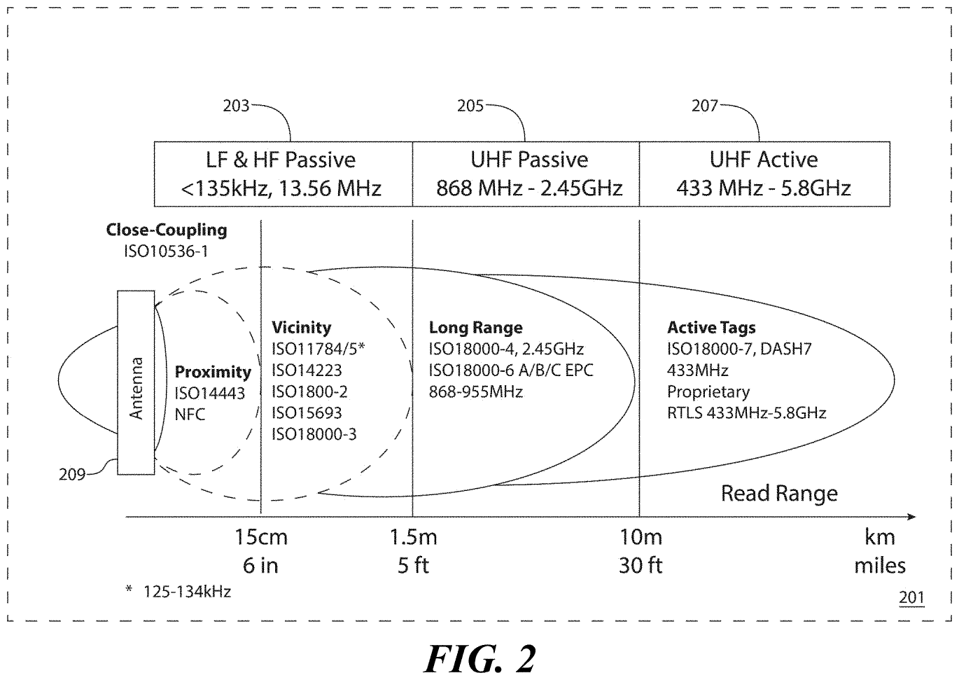

FIG. 2 illustrates some particular, nonlimiting embodiments of the antenna 201 component of implantable chips which may be utilized in accordance with the teachings herein. As seen therein, embodiments of antennas are possible which operate passively at both low and high frequencies 203 (such as, for example, at less than 135 kHz and 13.56 MHz), which operate passively at ultrahigh frequencies (UHFs) 205 (such as, for example, in the bandwidth of 868 MHz to 2.45 GHz), or which operate actively at UHFs 207 (such as, for example, in the bandwidth of 433 MHz to 5.8 GHz). Nonlimiting examples of the antennas 203 include those selected from close-coupling antennas operating in accordance with the ISO10536-1 protocol; proximity antennas operating in accordance with the ISO14443 protocol; and vicinity antennas operating in accordance with at least one protocol selected from the group consisting of ISO11784/5 (125 kHz to 134 kHz), ISO14223 (125 kHz to 134 kHz), ISO18000-2 (125 kHz to 134 kHz), ISO15693 and ISO18000-3. Nonlimiting examples of the antennas 205 include long range antennas operating in accordance with at least one protocol selected from the group consisting of ISO18000-4 (2.45 GHz), ISO18000-6 A/B/C EPC 868 (955 MHz). Nonlimiting examples of the antennas 207 include active tags which operate in accordance with the ISO18000-7 or DASH7 protocols (433 MHz) or the proprietary RTLS protocol (433 MHz-5.8 GHz). The antennas 203 typically operate at read ranges of 0-15 cm (0-6 inches), while the antennas 205 typically operate at read ranges as great as 1.5 m to 10 m (5 ft to 30 ft), and the antennas 209 operate at read ranges of 30 ft or more.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims. It will also be appreciated that the various features set forth in the claims may be presented in various combinations and sub-combinations in future claims without departing from the scope of the invention. In particular, the present disclosure expressly contemplates any such combination or sub-combination that is not known to the prior art, as if such combinations or sub-combinations were expressly written out.

What is claimed is:

1. A system for reuniting a lost animal with its owner, comprising:
a plurality of implantable tags;
a browser-accessible website which registers users and associates each registered user with at least one of said plurality of implantable tags;
a software application;
a plurality of mobile devices, wherein each of said plurality of mobile devices is equipped with an operating system, a tangible memory with an instance of the software application installed therein, and a scanning device which is adapted to scan one of the plurality of implantable tags and retrieve identification information therefrom; and
a cloud-based platform which accepts queries from instances of the software application installed on the plurality of mobile devices and returns responses thereto, wherein each of the queries contains identification information retrieved from one of the plurality of implantable tags, and wherein each of the responses contains contact information for a registered user associated with the implantable tag.

2. The system of claim 1, wherein each of said plurality of implantable tags includes a microchip.

3. The system of claim 1, wherein each microchip contains an antenna.

4. The system of claim 3, wherein said antenna operates in accordance with at least one protocol selected from the group consisting of ISO18000-4 (2.45 GHz), ISO18000-6 A/B/C EPC 868 (955 MHz).

5. The system of claim 1, wherein each microchip is scannable at a plurality of frequencies.

6. The system of claim 1, wherein each microchip is scannable at first and second frequencies, wherein said first frequency is less than 135 kHz, and wherein said second frequency is at least 13.56 MHz.

7. The system of claim 1, wherein each microchip is scannable at first and second frequencies, wherein said first and second frequencies are in the range of 868 MHz to 2.45 GHz.

8. The system of claim 1, wherein each of the plurality of implantable tags is implanted in an animal associated with one of the registered users.

9. The system of claim 1, wherein said software application is downloadable from said browser-accessible website.

10. The system of claim 1, wherein said cloud-based platform accepts registration information from said browser-accessible website and maintains a registration database of registered users, wherein said registration database includes contact information for each registered user.

11. A method for reuniting a lost animal with its owner, comprising:
providing a software application;
providing at least one implantable tag to each of a plurality of users, wherein each of said plurality of users is associated with a mobile device equipped with an operating system, a tangible memory with an instance of the software application installed therein, and a scanning device which is adapted to scan one of the plurality of implantable tags and retrieve identification information therefrom;
using a browser-accessible website to register each of the plurality of users and to associate each registered user with at least one of said plurality of implantable tags; and
using a cloud-based platform to accept queries from instances of the software application installed on the plurality of mobile devices and to return responses thereto, wherein each of the queries contains identification information retrieved from one of the plurality of implantable tags, and wherein each of the responses contains contact information for a registered user associated with the implantable tag.

12. The method of claim 11, wherein each of said plurality of implantable tags includes a microchip.

13. The method of claim 11, wherein each microchip contains an antenna.

14. The method of claim 13, wherein said antenna operates in accordance with at least one protocol selected from the group consisting of ISO18000-4 (2.45 GHz), ISO18000-6 A/B/C EPC 868 (955 MHz).

15. The method of claim 11, wherein each microchip is scannable at a plurality of frequencies.

16. The method of claim 11, wherein each microchip is scannable at first and second frequencies, wherein said first frequency is less than 135 kHz, and wherein said second frequency is at least 13.56 MHz.

17. The method of claim 11, wherein each microchip is scannable at first and second frequencies, wherein said first and second frequencies are in the range of 868 MHz to 2.45 GHz.

18. The method of claim 11, wherein each of the plurality of implantable tags is implanted in an animal associated with one of the registered users.

19. The method of claim 11, wherein said software application is downloadable from said browser-accessible website.

20. The method of claim 11, wherein said cloud-based platform accepts registration information from said browser-accessible website and maintains a registration database of registered users, wherein said registration database includes contact information for each registered user.
